(19) United States
(12) Patent Application Publication
(10) Pub. No.: US 2006/0289446 A1
(43) Pub. Date: Dec. 28, 2006

(54) Electric heater for flasks and such like

(76) Inventor: Enric Bonet Hernandez, Barcelona (ES)

Correspondence Address: STRIKER, STRIKER & STENBY, 103 EAST NECK ROAD, HUNTINGTON, NY, 11743, US

(21) Appl. No.: 11/418,355

(22) Filed: May 4, 2006

(30) Foreign Application Priority Data
May 10, 2005 (ES) U200501058

(51) Int. Cl. F27D 11/00

(52) U.S. Cl. 219/440

(57) ABSTRACT

It is composed of a heating body (1), made from material resistant to corrosion and high temperatures, with a cylindrical top and a spherical cap for a bottom, around which, in its outer upper part, is placed a plated resistor, or heating blanket (2), the action whereof will cause the heating of the heating body, in whose inner space the flask which is to be heated is placed. Said heating body has an upper flange, by way of a circular hoop (3), which is fastened between two flat circular rings (4-5), made of a material with high thermal insulation capacity, an upper cover (6) being placed on these rings, the central circular orifice whereof is completely in line with the top of the heating body (1). An insulating screen (8) is placed therein which goes around the whole of the heating body (1), laterally and below, all the inner space of the apparatus being filled with wool or thermal insulating shavings (9). There is an electronic control module (11), acting from the exterior (11a) of the chassis.

The present invention relates to an electric heater designed especially and specifically to heat flasks or other similar containers which are habitually used in laboratories and wherein the liquid product which is to be heated is placed beforehand, as part of a specific process, the essential characteristics of the aforementioned electric heater being described below.

As indicated in the previous paragraph, very frequently, with the aim of carrying out research in order to conduct an industrial process, one must heat the liquids, many of them of a corrosive nature, and which must be handled safely by putting them into appropriate containers, such as the known flasks made of heat resistant material.

The heating of the flask, together with the liquid placed inside it, is effected in a normal way, by means of the habitual use of electric heaters, consisting of a hollow body, wherein the flask is appropriately placed, the body whereof is heated to a high temperature with the help of electrical resistors which are coiled around its exterior, and even around its interior, according to the type of model.

The drawback with these heaters is that the electrical resistors which will cause the heating of the body wherein the flask has been placed, are situated in a part where they are easily vulnerable to the action of the liquids which are heated, either by pouring or dripping from the flask, or breakage thereof and spillage of the contents inside the heater.

This accidental situation provokes the short circuit of the electrical installation and, on almost all occasions, the breakage of one or several of the heating elements, with serious damage to the apparatus, which will have to be adequately repaired as it creates a risk of electrocution to the user.

The heater which is the object of the present invention offers a practical and economic solution of a heating element composed of a shielded resistor, referred to as a heating blanket, which is positioned embracing the exterior of the heating body of the appliance, so that, in the case of breakage of the flask or pouring or dripping of the liquid, the latter can not come into contact with said heating blanket, as it is not in contact with the outside.

The heater is equipped with a connection to earth, in accordance with the regulations currently in force, and its heating body is completely watertight, so that it can heat the flasks in four different ways:
a) By transmission or direct contact of the flask with the walls of the aforementioned heating body;
b) By radiation-convection, the flask not being in contact with the inside walls of the body and the heat being transmitted through the air which surrounds the flask inside the body;
c) By conduction, through the mass of a fluid, such as water or a thermal fluid, which fills the inside of the heating body wherein the flask has been submerged, or through a solid mass, specifically and wherein the flask has been submerged; or
d) Also by conduction, through a solid granulated mass, such as sand, in which the flask which is to be heated has been submerged.

The polivalence of the heater which is the object of the present invention is evident, increased by the possibility of presenting, as a practical embodiment, apparatus with bodies of different sizes, with the aim of heating flasks also of differing volume, as well as the presentation of the individual heater or the set of heaters, with two or more bodies.

The repeatedly mentioned body of the heating apparatus will be manufactured from metallic material, coated with ceramic material with high resistance to the action of corrosive liquids and high temperatures, or with stainless steel, with resistance characteristics similar to those of ceramics.

In the remainder of the description reference will be made to different components of the apparatus. To that end some drawings are attached wherein, by way of an unrestricted example, a practical embodiment of the heater which is the object of the present invention has been represented.

In said drawings,

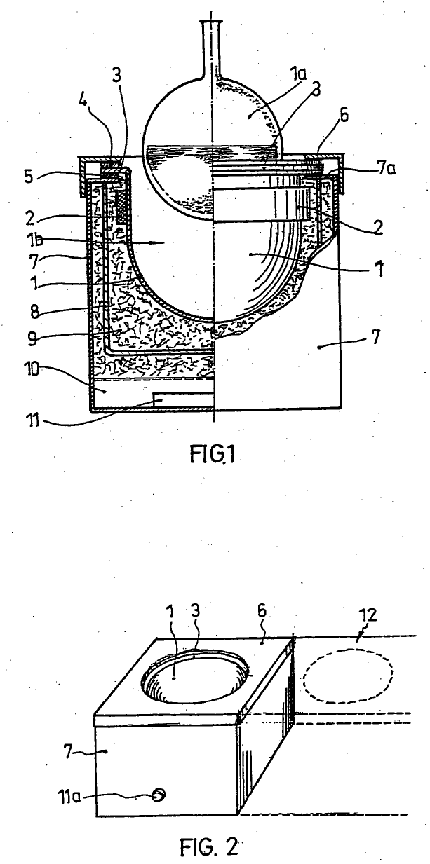

FIG. 1 is an elevated and partly sectioned elevational view of the unit, showing the flask separated from its position inside the heating body; and

FIG. 2 is a perspective view of an individual apparatus, indicating the possibility of multiple embodiment, in a set.

In accordance with these drawings, the heater for flasks and such like is composed of a heating body (1), made as previously indicated, of metallic material, coated with a layer of ceramic material or stainless steel, which has a cylindrical top and a spherical cap for a bottom, having a plated resistor or heating blanket (2) going completely around the top outer part of the heating body (1).

Said body (1) has an upper flange, by way of a circular hoop (3), which is positioned, by way of a “sandwich” between two circular rings (4) and (5), made of material with thermal insulation capacity.

On these insulating rings (4) and (5) is placed the appropriate upper cover (6), equipped with a central orifice completely in line with the top of the heating body (1), and with a vertical flange in square, which covers the upper contour of the chassis (7), which composes the lateral or lower external part of the apparatus.

This chassis (7) is completed with its upper side (7a), flat and horizontal, provided with a central circular orifice which is completely in line with the upper part of the side of the heating body (1), the above-mentioned upper side (7a) of the chassis (7) being below the lower insulating ring (5).

With the components of the apparatus positioned in this way, the set of the two insulating rings (4) and (5), with the upper hoop (3) of the heating body (1) completely rest on the upper side (7a) of the chassis (7), and together with them also the heating body (1), all of them perfectly held together by the upper cover (6) so that it constitutes a completely watertight unit, wherein no liquid can penetrate and, consequently, it can not suffer from any imperfections or faults.

Inside the space delimited between the chassis (7) and the heating body (1) is placed an insulating screen (8), which goes around the whole of said body, laterally and below, all of this completed by a filling of wool or shavings of insulating material (9), which guarantee a total thermal output from the apparatus, without any loss of heat to the outside, insulation also guaranteed by the action of the insulating rings (4) and (5), which prevent the transmission and consequent heat loss through the upper circular loop (3) of the heating body (1).

This complete insulation, as well as preventing the possible losses of heat, is a safety factor for the user, as it is not in contact with the heating elements.

The flask (1a), with the liquid which is to be heated, will be positioned in the inner space (1b) of the heating body (1), according to the manner of heating which is used, as was previously described.

The functioning of the heating system is based on the action of an electronic module control (11), placed in the inner lower part (10) of the chassis (7), completely insulated from the part of the apparatus which gives off heat. This electronic module will be controlled from the outside by means of the appropriate control (11a).

As a practical embodiment variant, the apparatus which is described could present its chassis enlarged sideways (12), so that it can hold one or more additional heating bodies and therefore, function as a unit.

It can also be presented, as a practical embodiment variant, an apparatus the chassis whereof, instead of being quadrangular prismatic, as it is represented in FIG. 2, is cylindrical, in accordance with space requirements of the exterior aspect.

It must be pointed out, because of all this, that any variation in the putting into practice of the invention which has been described, the dimensions, exterior forms, unitary or battery arrangement and types of materials used, said essentiality being summarised in the following claims.

1. Electric heater for flasks and such like, used in laboratories for the heating of liquids, which are generally corrosive, previously placed inside said containers, characterised in that it is composed of a heating body (1), made from material resistant to corrosion and high temperatures, such as metal coated with ceramic material or stainless steel, with a cylindrical top and a spherical cap for a bottom, around which, in its outer upper part, is placed a plated resistor, or heating blanket (2), perfectly secured, and the action whereof will cause the heating of the above mentioned heating body, in whose inner space the flask which is to be heated is placed.

2. Electric heater for flasks and such like, according to characterised in that the heating body has an upper flange, by way of a circular hoop (3), which is fastened between two flat circular rings (4-5), made of a material with high thermal insulation capacity, an upper cover (6) being placed on these rings, the central circular orifice whereof is completely in line with the top of the heating body (1), and which is equipped with a vertical flange which covers the upper contour of the chassis (7) which will compose the outer part of the apparatus, sides and base, chassis which, in a practical embodiment variant, will be extended laterally with the aim of enabling the position of more than one heating body, in a unitary functioning arrangement.

3. Electric heater for flasks and such like, according to characterised in that the chassis has a flat, horizontal upper side (7a), equipped with a circular orifice with a diameter equal to the outer diameter of the heating body (1), so that the unit composed of the two insulating rings (4-5) and the upper hoop (3) of the heating body will be perfectly propped up on this upper side of the chassis, and secured by the upper cover fitted on them, in the same way being, consequently, fixed in its functioning position, the whole of the heating body, constituting a completely watertight unit, which will not allow any fluid to penetrate into its interior.

4. Electric heater for flasks and such like, according to characterised in that an insulating screen (8) is placed therein which goes around the whole of the heating body (1), laterally and below, all the inner space of the apparatus being filled with wool or thermal insulating shavings (9), guaranteeing the retention of the heat generated by the heating blanket (2), which will not transmit towards the chassis, in the same way that the action of the insulating rings (4-5) on the circular hoop of the heating body (1) will prevent any heat loss through that upper part of the apparatus.

5. Electric heater for flasks and such like, according to characterised in that it has an electronic control module (11), acting from the exterior (11a) of the chassis and positioned in the lower part (10) of the apparatus, appropriately insulated from the heating zone.
